(19) United States
(12) Patent Application Publication
(10) Pub. No.: US 2025/0205963 A1
(43) Pub. Date: Jun. 26, 2025

(54) METHOD FOR PRODUCING A PLASTIC MOLDING

(71) Applicant: tooz technologies GmbH, Aalen (DE)

(72) Inventors: Joerg PUETZ, Aalen (DE); Markus DIAMANT, Huettlingen (DE); Bjoern HERDT, Bergisch Gladbach (DE)

(21) Appl. No.: 18/846,617

(22) PCT Filed: Mar. 10, 2023
(86) PCT No.: PCT/EP2023/056155

§ 371 Date: Sep. 12, 2024

(30) Foreign Application Priority Data
Mar. 14, 2022 (DE) 10 2022 105 839.5

(51) Int. Cl. B29C 51/10; B29C 51/26; B29L 11/00

(52) U.S. Cl. CPC B29C 51/10; B29C 51/262; B29C 2791/007; B29L 2011/00

(57) ABSTRACT

A plastic molding can be produced by (a) placing a plastic film on a main frame having a first through-opening, (b) heating the plastic film lying on the main frame, and (c) applying a fluid pressure medium to the plastic film lying on the main frame and heated in step (b). The plastic film is pushed against a mold, thereby forming the film to give a plastic molding. In step (a) a tensioning frame is applied to the plastic film lying on the main frame and is positioned such that the tensioning frame pushes the plastic film in the edge region against the upper face of the main frame, thereby fixating it. The second through-opening in the tensioning frame is at least partially opposite the first through-opening in the main frame. Step b) is carried out with the plastic film fixated between the main frame and the tensioning frame.

### PRIORITY

This application claims the priority of German patent application DE 10 2022 105 839.5 filed Mar. 14, 2022, which is hereby incorporated herein by reference in its entirety.

### FIELD

The present invention relates to a method of producing a polymer molding and especially a polymer molding for optical applications.

### BACKGROUND

Such polymer moldings can be produced from a polymer film by high-pressure forming (also known as the Niebling process). Such a high-pressure forming operation involves heating the polymer film (frequently above its softening point) and then pressing it by means of high pressure (up to 300 bar and preferably isostatically) against a mold. In this way, it is possible to reproducibly achieve high contour accuracy in impressions (with tolerances of, for example, less than +/−0.4 mm). Further details of such a high-pressure forming operation can be found, for example, in DE 10 2008 050 564 A1.

Since the polymer films used are generally produced via a flat film extrusion process and the final surface structure (for example gloss and thickness) is created by rolling, there can be anisotropic internal stresses. An adverse result of the necessary heating for the high-pressure forming described is then that the heating can release these intrinsic anisotropic stresses and can lead to warpage. Thus, even small corrugations/folds in the heating operation can have the effect that the required accuracy is no longer obtained in the molding operation.

### SUMMARY

An object of the invention is to provide an improved method of producing a polymer molding in which the disadvantages described at the outset can be avoided as far as possible.

The tension frame can fix or clamp the polymer film uniformly in the region of the edge zone and especially along a continuous line around the first through opening, which can effectively prevent unwanted warpage in the course of heating. The edge zone may be defined, for example, as the region of the top side of the base frame, which extends from the edge of the through opening up to a predetermined distance value from the edge of the first through opening. The edge zone can also be defined in that it is the region of the top side of the base frame on which the polymer film lies and in which it is pressed against the top side by the tension frame when the polymer film covers the first through opening.

The first and/or second through opening may especially be circular. However, an oval shape or any other shape is also possible.

The tension frame can press the polymer film against the top side of the base frame along a continuous pathway that surrounds the first through opening.

In particular, the tension frame may have an annular groove that encloses the second through opening. There may be a seal in the groove, which presses against the polymer film. In particular, the annular groove may press against the polymer film in a region that lies above the first through opening.

The groove and/or the seal may be circular or else have any other ring shape, for example square, rectangular, oval, polygonal, or the shape of any other continuous path.

The base frame may have several projecting pins on its top side. The tension frame may have corresponding holes or adjustment holes. In step a), the tension frame may be pushed over the pins by its adjustment holes and hence positioned on the polymer film.

Alternatively, it is possible that the tension frame is positioned between the pins, which serve as stop for the tension frame. In that case, the tension frame may be formed without the corresponding holes or adjustment holes. The function of the stop, rather than by pins, may also be implemented by any other kind of mechanical stop or stop element.

In addition, the tension frame may have a planar or nonplanar bottom side that rests on the polymer film. The formation of the nonplanar bottom side may be implemented such that this achieves better fixing of the polymer film. For instance, the tension frame may have, on the bottom side, in the region of the edge zone, spikes, teeth and/or a rough surface for fixing of the polymer film. The top side of the base frame may be designed to be planar or designed to be nonplanar. The nonplanar top side may be implemented by spikes, teeth and/or a rough surface. This can improve the fixing of the polymer film.

In addition, a clamping means may be provided, which subjects the tension frame to a force that presses the tension frame against the base frame and hence increases the clamping effect already exerted on the polymer film due to the weight force of the tension frame. The clamping means can be implemented by clamping elements, such as, for example, by a screw connection and/or one or more clamping levers, or else by means of magnetic force.

There may be a pressure chamber in step c) in which the forming of the polymer film is conducted.

The pressure chamber can be formed, for example, in that a wall surrounding the mold presses the polymer film against the tension frame, such that the tension frame is part of the pressure chamber and the base frame is not part of the pressure chamber.

In addition, the pressure chamber can be formed in that the polymer film is clamped directly between a wall surrounding the mold and a wall of a first subchamber, such that both the tension frame is not part of the pressure chamber and the base frame is not part of the pressure chamber.

In particular, the pressure chamber can be formed such that the polymer film is lifted off the base frame, such that there is a gap, for example an air gap, between the polymer film and the base frame during the period at which the pressure chamber is formed.

With the exception of the polymer film, the elements that form the pressure chamber are preferably formed from metal. It is preferable to provide just one (generally annular) seal per separation plane between two metal faces of the metal elements (without taking account of the polymer film), in order to ensure the integrity in that separation plane. Thus, for assurance of integrity, the sequence may be metal-seal-metal, metal-seal-polymer film-metal and metal-polymer film-seal-metal.

The annular seal may be circular, oval, square, rectangular, polygonal, or have the shape of any other continuous path.

All the seals described may be produced, for example, from a heat-resistant elastomer (for example fluoro rubber).

In step c), the mold may be provided with a contour, where the forming is achieved in that the fluid pressure medium presses the polymer film against the contour.

The forming in step c) is preferably effected isostatically.

The polymer film may include any polymer that the person skilled in the art would select for forming. In particular, the polymer is a thermoplastic polymer.

Materials used for the polymer film may especially be thermoplastic polymers, for example polycarbonate, PMMA (polymethylmethacrylate), PA (polyamide), PS (polystyrene), PET (polyethylene terephthalate), PEN (polyethylene naphthalate), TAC (cellulose acetate), COP/COC (cycloolefin polymer or copolymer). In addition, it is also possible to use reactive polymer precursors that are partly or fully cured thermally or by radiative hardening during the forming process or in a downstream process step. Examples of these can be found in the field of polyurethane chemistry inter alia. In addition, it is possible to use coated and/or pretreated films, co-extruded films, hybrid films and/or composite films.

The thermoplastic polymer may preferably be at least one thermoplastic polymer selected from polymers of ethylenically unsaturated monomers and/or polycondensates of bifunctional reactive compounds and/or polyaddition products of bifunctional reactive compounds, preferably at least one thermoplastic polymer selected from polymers of ethylenically unsaturated monomers and/or polycondensates of bifunctional reactive compounds. For particular applications, it may be advantageous and accordingly preferable to use a transparent thermoplastic polymer.

Particularly suitable thermoplastic polymers are polycarbonates or copolycarbonates based on diphenols, poly- or copolyacrylates and poly- or copolymethacrylates, by way of example and with preference polymethylmethacrylate or poly(meth)acrylate (PMMA), poly- or copolymers with styrene, by way of example and with preference polystyrene or polystyrene-acrylonitrile (SAN), thermoplastic polyurethanes, and polyolefins, by way of example and with preference polypropylene types or polyolefins based on cycloolefins (e.g. TOPAS©, Hoechst), poly- or copolycondensates of terephthalic acid, by way of example and with preference poly- or copolyethylene terephthalate (PET or CoPET), glycol-modified PET (PETG), glycol-modified poly- or copolycyclohexanedimethylene terephthalate (PCTG) or poly- or copolybutylene terephthalate (PBT or CoPBT), or mixtures of the above. However, polyolefins, for example polypropylene, without addition of other aforementioned thermoplastic polymers are less preferred.

Preferred thermoplastic polymers are polycarbonates or copolycarbonates, poly- or copolyacrylates, poly- or copolymethacrylates, or blends containing at least one of these thermoplastic polymers. Particular preference is given to polycarbonates or copolycarbonates, especially having average molecular weights Mw of 500 to 100 000, preferably of 10 000 to 80 000, more preferably of 15 000 to 40 000, or the blends thereof with at least one poly- or copolycondensate of terephthalic acid having average molecular weights Mw of 10 000 to 200 000, preferably of 26 000 to 120 000, or poly- or copolyacrylates and poly- or copolymethacrylates having average molecular weights Mw in the range from 30 000 to 300 000, more preferably in the range from 80 000 to 250 000.

Suitable poly- or copolycondensates of terephthalic acid in certain preferred embodiments are polyalkylene terephthalates. Suitable polyalkylene terephthalates are, for example, reaction products of aromatic dicarboxylic acids or the reactive derivatives thereof (e.g. dimethyl esters or anhydrides) and aliphatic, cycloaliphatic or araliphatic diols, and mixtures of these reaction products.

Preferred polyalkylene terephthalates can be prepared from terephthalic acid (or the reactive derivatives thereof) and aliphatic or cycloaliphatic diols having 2 to 10 carbon atoms by known methods (Kunststoff-Handbuch [Plastics Handbook], vol. VIII, p. 695 ff, Karl-Hanser-Verlag, Munich 1973).

Preferred polyalkylene terephthalates contain at least 80 mol %, preferably 90 mol %, of terephthalic acid radicals, based on the dicarboxylic acid component, and at least 80 mol %, preferably at least 90 mol %, of ethylene glycol and/or butane-1,4-diol and/or cyclohexane-1,4-dimethanol radicals, based on the diol component.

The preferred polyalkylene terephthalates may, as well as terephthalic acid radicals, contain up to 20 mol % of radicals of other aromatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates, as well as ethylene glycol or butane-1,4-diol glycol radicals, contain up to 80 mol % of other aliphatic diols having 3 to 12 carbon atoms or of cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and 2-ethylhexane-1,6-diol, 2,2-diethylpropane-1,3-diol, hexane-2,5-diol, 1,4-di([beta]-hydroxyethoxy)benzene, 2,2-bis(4-hydroxycyclohexyl)propane, 2,4-dihydroxy-1,1,3,3-tetramethylcyclobutane, 2,2-bis-(3-[beta]-hydroxyethoxyphenyl)propane and 2,2-bis-(4-hydroxypropoxyphenyl)propane (cf. DE-A 24 07 674, 24 07 776, 27 15 932).

The polyalkylene terephthalates may be branched via incorporation of relatively small amounts of tri- or tetrahydric alcohols or tri- or tetrabasic carboxylic acids, as described e.g. in DE-A 19 00 270 and U.S. Pat. No. 3,692,744. Examples of preferred branching agents are trimesic acid, trimellitic acid, trimethylolethane and -propane, and pentaerythritol.

Preferably not more than 1 mol % of the branching agent, based on the acid component, is used.

Particular preference is given to polyalkylene terephthalates that have been prepared solely from terephthalic acid and the reactive derivatives thereof (e.g. the dialkyl esters thereof) and ethylene glycol and/or butane-1,4-diol and/or cyclohexane-1,4-dimethanol radicals, and mixtures of these polyalkylene terephthalates.

Preferred polyalkylene terephthalates are also copolyesters that have been prepared from at least two of the abovementioned acid components and/or from at least two of the abovementioned alcohol components; particularly preferred copolyesters are poly(ethylene glycol/butane-1,4-diol) terephthalates.

The polyalkylene terephthalates used with preference as a component preferably have an intrinsic viscosity of about 0.4 to 1.5 dl/g, preferably 0.5 to 1.3 dl/g, in each case measured in phenol/o-dichlorobenzene (1:1 parts by weight) at 25° C.

In particularly preferred embodiments, the blend of at least one polycarbonate or copolycarbonate with at least one poly- or copolycondensate of terephthalic acid is a blend of at least one polycarbonate or copolycarbonate with poly- or copolybutylene terephthalate or glycol-modified poly- or copolycyclohexanedimethylene terephthalate. Such a blend of polycarbonate or copolycarbonate with poly- or copolybutylene terephthalate or glycol-modified poly- or copolycyclohexanedimethylene terephthalate may preferably be one having 1% to 90% by weight of polycarbonate or copolycarbonate and 99% to 10% by weight of poly- or copolybutylene terephthalate or glycol-modified poly- or copolycyclohexanedimethylene terephthalate, preferably with 1% to 90% by weight of polycarbonate and 99% to 10% by weight of polybutylene terephthalate or glycol-modified polycyclohexanedimethylene terephthalate, where the proportions add up to 100% by weight. More preferably, such a blend of polycarbonate or copolycarbonate with poly- or copolybutylene terephthalate or glycol-modified poly- or copolycyclohexanedimethylene terephthalate may be one having 20% to 85% by weight of polycarbonate or copolycarbonate and 80% to 15% by weight of poly- or copolybutylene terephthalate or glycol-modified poly- or copolycyclohexanedimethylene terephthalate, preferably with 20% to 85% by weight of polycarbonate and 80% to 15% by weight of polybutylene terephthalate or glycol-modified polycyclohexanedimethylene terephthalate, where the proportions add up to 100% by weight. Most preferably, such a blend of polycarbonate or copolycarbonate with poly- or copolybutylene terephthalate or glycol-modified poly- or copolycyclohexanedimethylene terephthalate may be one having 35% to 80% by weight of polycarbonate or copolycarbonate and 65% to 20% by weight of poly- or copolybutylene terephthalate or glycol-modified poly- or copolycyclohexanedimethylene terephthalate, preferably with 35% to 80% by weight of polycarbonate and 65% to 20% by weight of polybutylene terephthalate or glycol-modified polycyclohexanedimethylene terephthalate, where the proportions add up to 100% by weight. Very particularly preferred embodiments may involve blends of polycarbonate and glycol-modified polycyclohexanedimethylene terephthalate in the aforementioned compositions.

Suitable polycarbonates or copolycarbonates in preferred embodiments are particularly aromatic polycarbonates or copolycarbonates.

The polycarbonates or copolycarbonates may be linear or branched in a known manner.

These polycarbonate can be prepared in a known manner from diphenols, carbonic acid derivatives, optionally chain terminators and optionally branching agents. Details of the preparation of polycarbonates have been set out in many patent specifications over about the last 40 years. Reference shall be made here by way of example merely to Schnell, “Chemistry and Physics of Polycarbonates”, Polymer Reviews, Volume 9, Interscience Publishers, New York, London, Sydney 1964, to D. Freitag, U. Grigo, P. R. Muller, H. Nouvertne’, BAYER AG, “Polycarbonates” in Encyclopedia of Polymer Science and Engineering, Volume 11, Second Edition, 1988, pages 648-718, and finally to Dres. U. Grigo, K. Kirchner and P. R. Muller “Polycarbonate” [Polycarbonates] in Becker/Braun, Kunststoff-Handbuch, volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117-299.

Suitable diphenols may, for example, be dihydroxyaryl compounds of the general formula (I)

HO—Z—OH (I)

in which Z is an aromatic radical which has 6 to 34 carbon atoms and may contain one or more optionally substituted aromatic rings and aliphatic or cycloaliphatic radicals or alkylaryls or heteroatoms as bridge members.

Examples of suitable dihydroxyaryl compounds are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes, and the ring-alkylated and ring-halogenated compounds thereof.

These and other suitable further dihydroxyaryl compounds are described, for example, in DE-A 3 832 396, FR-A 1 561 518, in H. Schnell, Chemistry and Physics of Polycarbonates, Interscience Publishers, New York 1964, p. 28 ff.; p. 102 ff. and in D. G. Legrand, J. T. Bendler, Handbook of Polycarbonate Science and Technology, Marcel Dekker New York 2000, p. 72 ff.

Preferred dihydroxyaryl compounds are, for example, resorcinol, 4,4′-dihydroxydiphenyl, bis(4-hydroxyphenyl)methane, bis(3,5-dimethyl-4-hydroxyphenyl)methane, bis(4-hydroxyphenyl)-diphenylmethane, 1,1-bis(4-hydroxyphenyl)-1-phenylethane, 1,1-bis(4-hydroxyphenyl)-1-(1-naphthyl)ethane, 1,1-bis(4-hydroxyphenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bis(4-hydroxyphenyl)-4-methylcyclohexane, 1,3-bis[2-(4-hydroxyphenyl)-2-propyl]benzene, 1,1′-bis(4-hydroxyphenyl)-3-diisopropylbenzene, 1,1′-bis(4-hydroxyphenyl)-4-diisopropylbenzene, 1,3-bis[2-(3,5-dimethyl-4-hydroxyphenyl)-2-propyl]benzene, bis(4-hydroxyphenyl) ether, bis(4-hydroxyphenyl) sulfide, bis(4-hydroxyphenyl) sulfone, bis(3,5-dimethyl-4-hydroxyphenyl) sulfone and 2,2′,3,3′-tetrahydro-3,3,3′,3′-tetramethyl-1,1′-spirobi-[1H-indene]-5,5′-diol or dihydroxydiphenylcycloalkanes of the formula (Ia)

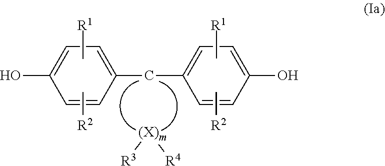

in which
R¹ and R² are independently hydrogen, halogen, preferably chlorine or bromine, C₁-C₈-alkyl, C₅-C₆-cycloalkyl, C₆-C₁₀-aryl, preferably phenyl, and C₇-C₁₂-aralkyl, preferably phenyl-C₁-C₄-alkyl, especially benzyl,
m is an integer from 4 to 7, preferably 4 or 5, R³ and R⁴ are choosable individually for each X and are independently hydrogen or C₁-C₆-alkyl, and X is carbon, with the proviso that, on at least one atom X, R³ and R⁴ are both alkyl. Preferably, in the formula (Ia), on one or two atom(s) X, especially on just one atom X, R³ and R⁴ are both alkyl.

The preferred alkyl radical for the R³ and R⁴ radicals in formula (Ia) is methyl. The X atoms in the alpha position to the diphenyl-substituted carbon atom (C-1) are preferably not dialkyl-substituted; by contrast, preference is given to alkyl disubstitution in the beta position to C-1.

Particularly preferred dihydroxydiphenylcycloalkanes of the formula (Ia) are those having 5 and 6 ring carbon atoms X in the cycloaliphatic radical (m=4 or 5 in formula (Ia)), for example the diphenols of the formulae (Ib) to (Id)

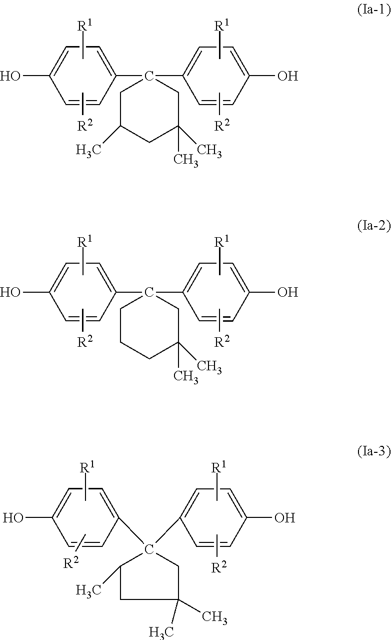

A very particularly preferred dihydroxydiphenylcycloalkane of the formula (Ia) is 1,1-bis(4-hydroxyphenyl)-3,3,5-trimethylcyclohexane (formula (Ia-1) with R¹ and R²═H).

Such polycarbonates can be prepared according to EP-A 359 953 from dihydroxydiphenylcycloalkanes of the formula (Ia).

Particularly preferred dihydroxyaryl compounds are resorcinol, 4,4′-dihydroxydiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxydiphenyl, 2,2-bis(4-hydroxyphenyl)propane and 1,1-bis(4-hydroxyphenyl)-3,3,5-trimethylcyclohexane.

It is possible to use either one dihydroxyaryl compound to form homopolycarbonates or various dihydroxyaryl compounds to form copolycarbonates. It is possible to use either one dihydroxyaryl compound of the formula (I) or (Ia) to form homopolycarbonates or two or more dihydroxyaryl compounds of the formula (I) and/or (Ia) to form copolycarbonates. It is possible here for the various dihydroxyaryl compounds to be bonded to one another either randomly or in blocks. In the case of copolycarbonates formed from dihydroxyaryl compounds of the formulae (I) and (Ia), the molar ratio of dihydroxyaryl compounds of the formula (Ia) to any other dihydroxyaryl compounds of the formula (I) to be used additionally is preferably between 99 mol % (Ia):1 mol % (I) and 2 mol % (Ia):98 mol % (I), preferably between 99 mol % (Ia):1 mol % (I) and 10 mol % (Ia):90 mol % (I) and especially between 99 mol % (Ia):1 mol % (I) and 30 mol % (Ia):70 mol % (I).

A very particularly preferred copolycarbonate can be prepared using 1,1-bis(4-hydroxyphenyl)-3,3,5-trimethylcyclohexane and 2,2-bis(4-hydroxyphenyl)propane dihydroxyaryl compounds of the formulae (Ia) and (I).

Poly- or copolycarbonates prepared using dihydroxyaryl compound of the formula (Ia) typically have a higher glass transition temperature T_{g} and a higher Vicat softening temperature B/50 than polycarbonate based on 2,2-bis(4-hydroxyphenyl)propane as dihydroxyaryl compound.

Suitable carbonic acid derivatives may, for example, be diaryl carbonates of the general formula (II)

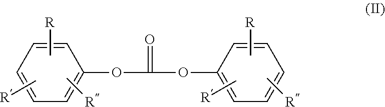

in which R, R′ and R″ are independently the same or different and are hydrogen, linear or branched C₁-C₃₄-alkyl, C₇-C₃₄-alkylaryl or C₆-C₃₄-aryl, R may additionally also be —COO—R where R is hydrogen, linear or branched C₁-C₃₄-alkyl, C₇-C₃₄-alkylaryl or C₆-C₃₄-aryl.

Preferred diaryl carbonates are, for example, diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-iso-butylphenyl) carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4-isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methyl-1-phenylethyl)phenyl phenyl carbonate, di[4-(1-methyl-1-phenylethyl)phenyl]carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl]carbonate, di[4-(2-naphthyl)phenyl]carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, (methyl salicylate) phenyl carbonate, di(methyl salicylate) carbonate, (ethyl salicylate) phenyl carbonate, di(ethyl salicylate) carbonate, (n-propyl salicylate) phenyl carbonate, di(n-propyl salicylate) carbonate, (isopropyl salicylate) phenyl carbonate, di(isopropyl salicylate) carbonate, (n-butyl salicylate) phenyl carbonate, di(n-butyl salicylate) carbonate, (isobutyl salicylate) phenyl carbonate, di(isobutyl salicylate) carbonate, (tert-butyl salicylate) phenyl carbonate, di(tert-butyl salicylate) carbonate, di(phenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl]carbonate and di(methyl salicylate) carbonate.

Very particular preference is given to diphenyl carbonate.

It is possible to use either one diaryl carbonate or various diaryl carbonates.

In order to control or vary the end groups, it is additionally possible to use, for example, one or more monohydroxyaryl compound(s) as chain terminator, which have not been used for preparation of the diaryl carbonate(s) used. These may be those of the general formula (III)

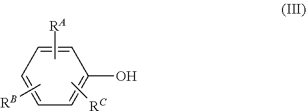

where R^{A} is linear or branched C₁-C₃₄-alkyl, C₇-C₃₄-alkylaryl, C₆-C₃₄-aryl or is —COO—R^{D} where R^{D} is hydrogen, linear or branched C₁-C₃₄-alkyl, C₇-C₃₄-alkylaryl or C₆-C₃₄-aryl, and R^{B}, R^{C} are the same or different and are independently hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol, 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

Preference is given to 4-tert-butylphenol, 4-isooctylphenol and 3-pentadecylphenol.

Suitable branching agents may compounds having three and more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis-(4-hydroxyphenyl)cyclohexyl]propane, 2,4-bis(4-hydroxyphenylisopropyl)phenol and tetra(4-hydroxyphenyl)methane.

Other suitable compounds having three and more functional groups are, for example, 2,4-dihydroxybenzoic acid, trimesic acid/trimesoyl trichloride, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

Polymethyl(meth)acrylates used may be either polymethyl(meth)acrylate (PMMA) or impact-modified PMMA (imPMMA), or blends of PMMA or of imPMMA. They are available under the Plexiglas brand from Röhm GmbH. Polymethyl(meth)acrylate means both polymers of methacrylic acid and the derivatives thereof, for example the esters thereof, and polymers of acrylic acid and the derivatives thereof, and also mixtures of the two aforementioned components.

Preference is given to polymethyl(meth)acrylate polymers having a methyl methacrylate monomer content of at least 80% by weight, preferably at least 90% by weight, and optionally 0% by weight to 20% by weight, preferably 0% by weight to 10% by weight, further in a vinylically copolymerizable monomers, for example C₁- to C₈-alkyl esters of acrylic acid or of methacrylic acid, e.g. methyl acrylate, ethyl acrylate, butyl acrylate, butyl methacrylate, hexyl methacrylate, cyclohexyl methacrylate, and also styrene and styrene derivatives, for example [alpha]-methylstyrene or p-methylstyrene. Further monomers may be acrylic acid, methacrylic acid, maleic anhydride, hydroxy esters of acrylic acid or hydroxy esters of methacrylic acid.

The thermoplastic polymers may additionally contain fillers, and if so preferably in an amount of up to 30% by weight. Such fillers are known to the person skilled in the art. For example, it is possible to use inorganic fillers, for example inorganic pigments.

The suitable inorganic pigments include, for example, oxides such as silicon dioxide, titanium dioxide, zirconium dioxide, iron oxide, zinc oxide and chromium(III) oxide, sulfides such as zinc sulfide and cadmium sulfide, and compounds such as barium sulfate, cadmium selenide, ultramarine and nickel chromium titanate. Likewise suitable as pigments in the present context are carbonates, such as calcium carbonate and barium carbonate, and carbon black. A very particularly preferred color pigment is barium sulfate. These pigments are incorporated into the composition in an amount of 0.1% to 30% by weight, preferably 2% to 15% by weight, based on the weight of the composition.

The thermoplastic polymers may additionally contain scattering pigments as fillers, which are well known to the person skilled in the art and are described, for example, in WO-A 2007/045380.

These fillers may preferably be used in average particle sizes of 0.01 μm to 50 μm.

The thermoplastic polymers may additionally contain additives in dissolved or dispersed form that serve for processibility, stabilization or functionalization. For example, it is possible to use separating aids and thermal stabilizers in order to improve processing by injection molding or in an extrusion process and/or forming process. For prolonged stabilization, the polymers may also contain UV absorbers and also light stabilizers (HALS, hindered amine light stabilizers). It is likewise possible to use dyes and pigments in order to create specific absorption and/or reflection properties. Furthermore, it is also possible to add functional components, for example photochromic dyes, that cause a change in color under UV irradiation, or dichroitic dyes, with the aid of which it is possible to achieve polarizing properties.

The pieces of film made of at least one thermoplastic polymer that are to be formed in accordance with the present methods may also be a multilayer coextrusion film made from at least two different thermoplastic polymers.

The polymer films are typically produced by extrusion or coextrusion.

The polymer films may at least to some degree be printed on one side or both sides, metallized and/or coated in some other way.

It will be apparent that the features mentioned above and those still to be elucidated below are usable not just in the combinations specified but also in other combinations or on their own, without leaving the scope of the present invention.

The invention will be elucidated in detail hereinafter by working examples with reference to the appended drawings, which likewise disclose features essential to the invention. These working examples serve merely for elucidation and should not be interpreted in a restrictive manner. For example, a description of a working example having a multitude of elements or components should not be interpreted such that all these elements or components are necessary for implementation. Instead, other working examples may also contain alternative elements and components, fewer elements or components, or additional elements or components. Elements or components from different working examples may be combined with one another, unless stated otherwise. Modifications and variations that are described for one of the working examples may also be applicable to other working examples. For avoidance of repetition, identical or mutually corresponding elements in different figures may be given the same reference numerals and not be elucidated again.

### BRIEF DESCRIPTION OF THE DRAWINGS

FIG. 1 shows a section view of a working example of the fixing unit according to certain embodiments of the invention;

FIG. 2 shows a top view of the fixing unit from FIG. 1;

FIG. 3 shows a front view of the bottom side of the tension frame from FIG. 1;

FIG. 4 is a schematic diagram of the apparatus for high-pressure forming;

FIG. 5 shows an enlarged section view of the fixing unit positioned on a slide of the high-pressure forming apparatus;

FIG. 6 is a schematic diagram of the heating device of the high-pressure forming apparatus;

FIGS. 7 to 9 are schematic diagrams of the high-pressure device of the high-pressure forming apparatus for elucidation of the isostatic high-pressure forming of the polymer film performed;

FIG. 10 shows a section view of the polymer molding produced;

FIG. 11 shows a section view of a further working example of the fixing unit according to certain embodiments of the invention;

FIG. 12 shows a section view of a further working example of the fixing unit according to certain embodiments of the invention;

FIG. 13 shows a top view of the fixing unit from FIG. 12, and

FIGS. 14 and 15 are schematic diagrams of the high-pressure device of the high-pressure forming apparatus for elucidation of the isostatic high-pressure forming of the polymer film performed in a further working example.

### DETAILED DESCRIPTION

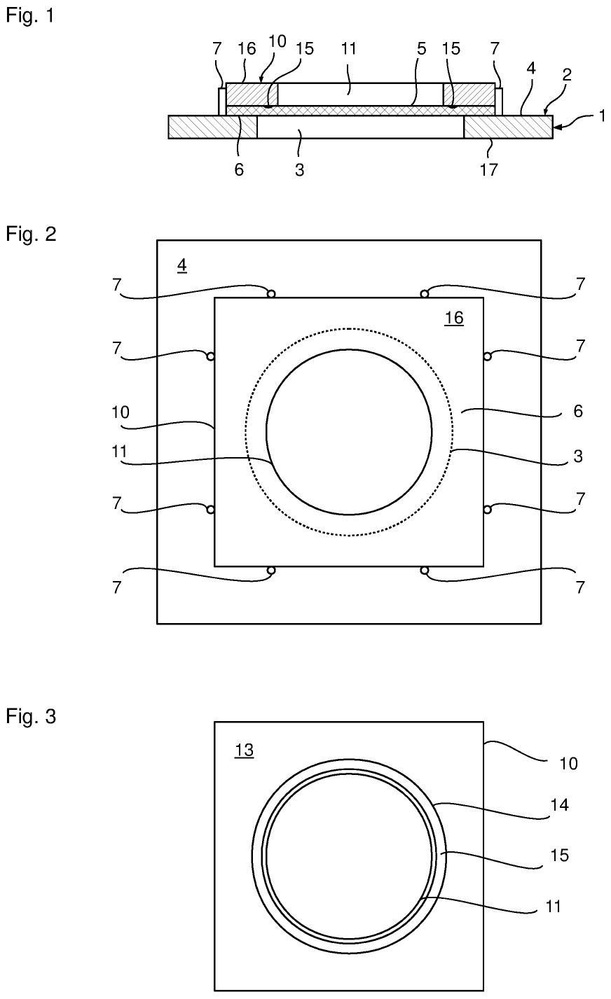

In the working example shown in FIG. 1, the fixing unit 1, for fixing of a polymer film 5 for an apparatus for high-pressure forming, has a base frame 2 with a first through opening 3 and a top side 4.

On the top side 4 of the base frame 2 (also called base plate 2 hereinafter), the polymer film 5 is positioned such that it covers the entire first through opening 3 and lies on an edge zone 6 of the top side 4 that bounds the first through opening 3. The first through opening 3 is in circular form, as can be inferred, for example, from the top view in FIG. 2. Of course, different boundary contours of the first through opening 3 are also possible, for example square, rectangular, oval or polygonal.

The base frame 2 has eight pins 7 arranged in a rectangle (in a square here) in the edge zone 6, which protrude upward from the top side 4, although other arrangements and/or a different number of pins 7 and geometries other than pins are of course also possible.

The polymer film 5 in the working example described here is in square form such that it can be placed exactly into the region bounded by the pins 7 on the top side 4 of the base frame 2. By means of additional pins (or other geometries and/or a cutout), unambiguous positioning can also be achieved. This may be advantageous, for example, in the case of preprinted polymer films 5.

A tension frame 10 is positioned on the polymer film 5 (FIGS. 1 and 2), which has a second circular through opening 11 having smaller diameter than the first through opening 3 of the base frame 2. Of course, different boundary contours of the second through opening 11 are also possible, for example square, rectangular, oval or polygonal. The tension frame 10 is likewise in square form such that it can be positioned on the polymer film 5 exactly in the region bounded by the pins 7. The tension frame 10 then lies on the polymer film 5 by its bottom side 13 and hence presses it two-dimensionally onto the edge zone 6 of the top side 4 of the base frame 2.

The edge zone 6 is thus the region of the top side 4 that extends from the edge of the first through opening 3 as far as the region bounded by the pins 7 on the top side 4.

The pins 7 thus serve firstly to define the position of the polymer film 5 on the base frame 2, and to define the position of the tension frame 10 on the polymer film 5. Secondly, the pins 7 serve as a stop, and ensure that the positions of polymer film 5 and tension frame 10 relative to the base frame 2 and in particular relative to the first through opening 3 of the base frame 2 are reliably maintained, even when the fixing unit 1 is being moved in the apparatus for high-pressure forming, as described hereinafter.

The square shape of the polymer film 5 and of the tension frame 10 is merely illustrative. It is of course also possible to implement different outline contours. What is essential is the two-dimensional and preferably all-round contact of the polymer film 5 with the top side 4 of the base frame 2 because of the tension frame 10 that lies atop the polymer film 5.

As apparent in the section diagram of FIG. 1, the base frame 2 and the tension frame 10 are designed such that, on fixing of the polymer film 5, the two through openings 3, 11 are aligned coaxially to one another.

As can be inferred from FIG. 3 in particular, the bottom side 13 of the tension frame 10 has an annular groove 14 having a greater internal diameter than the diameter of the first through opening 3. In the groove 14 is an annular seal 15 that protrudes beyond the bottom side 13. The seal 15 may be produced from a heat-resistant elastomer, for example FKM (fluoro rubber). As shown in FIG. 1, the seal 15 thus lies on the top side of the polymer film 5 in a region within the first through opening 3.

In the embodiment described here, both the bottom side 13 and a top side 16 of the tension frame 10 are in planar form. The polymer film 5 is thus fixed by the weight force of the tension frame 10 with which it presses the polymer film 5 against the top side 4 of the base frame 2.

The tension frame 10 may have a sheet thickness of 2 mm-50 mm, preferably of 5 mm-10 mm. The sheet thickness of the tension frame 10 may especially be chosen such that the weight force of the tension frame 10 is sufficient to assure the desired fixing of the polymer film 5.

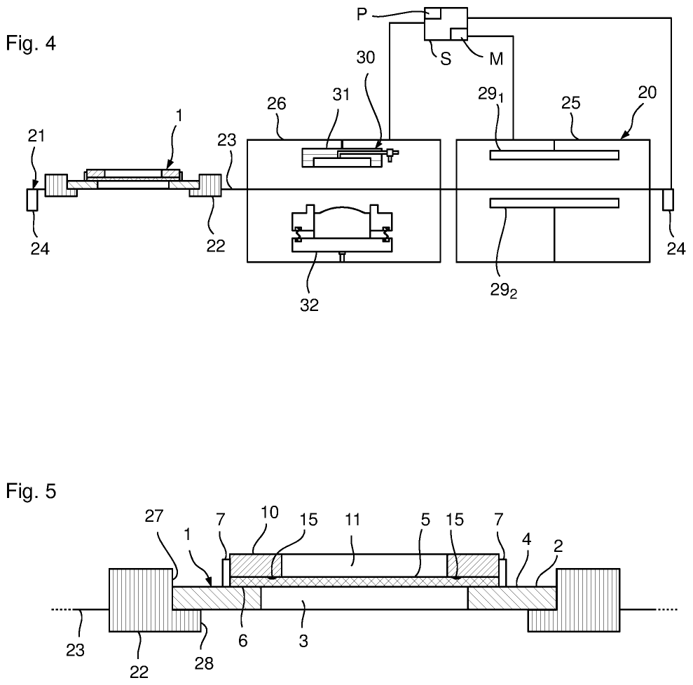

The fixing unit 1 is designed for an apparatus 20 for high-pressure forming, as shown schematically in FIG. 4. The high-pressure forming apparatus 20 comprises a conveying device 21 with a slide 22 for accommodation of the fixing unit 1, a conveyor belt or a conveyor chain 23 and a drive 24, a heating device 25, a high-pressure device 26, and a control unit S for control of the high-pressure forming apparatus 20. The control unit S may have, for example, a processor P and a memory M.

In the diagram in FIG. 4 and the enlarged partial diagram in FIG. 5, the slide 22 is in the load/unload position, with the complete fixing unit 1 already placed on the slide 22 or in a depression 27 in the slide 22. In the region of the depression 27, the slide has a third through opening 28 which is larger than the first and second through openings 3, 11, and fully covers the first and second through openings 3, 11, as is readily apparent, for example, in the enlarged diagram in FIG. 5.

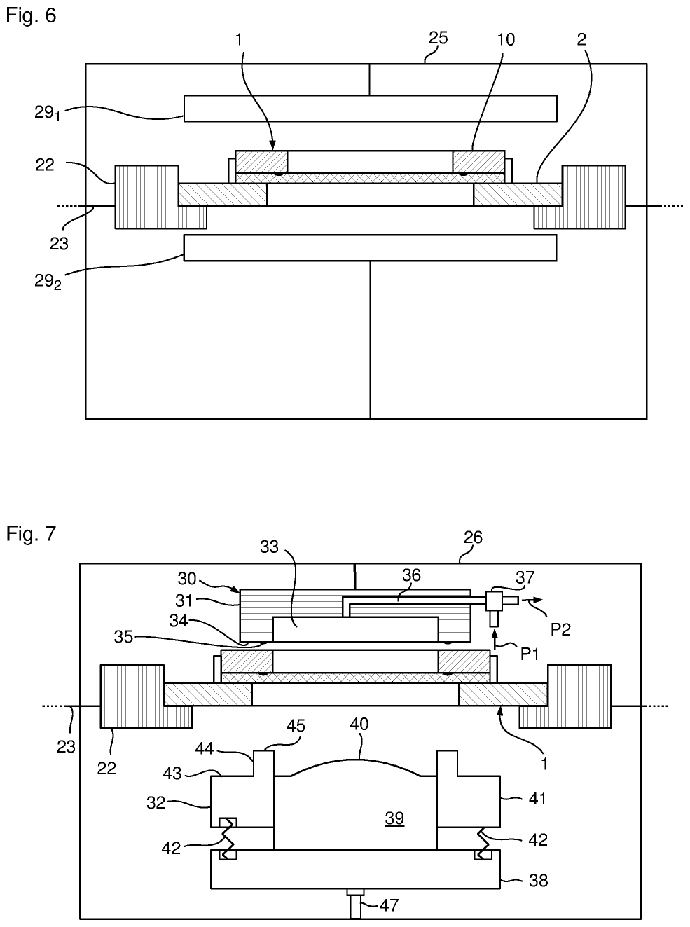

A fixing unit 1 thus secured on the slide 22 can be transported by means of the conveying device 21 into the heating device 25, in which there are disposed, as shown schematically in FIGS. 4 and 6, two actuatable two-dimensional heat sources 29₁ and 29₂. The two heat sources 29₁ and 29₂ are preferably arranged and/or designed such that they provide the same heating output. If the two-dimensional heat sources 29₁ and 29₂ already provide the same heating output, this can be achieved e.g. in that they have the same distance from the polymer film 5 in a direction from one heat source 29₁ to the other heat source 29₂. However, it is possible in practice for differences to arise through convection for example, which are then balanced out by controlling the power of the two two-dimensional heat sources 29₁ and 29₂.

The heat sources 29₁ and 29₂ are used to heat the polymer film 5 fixed in the fixing unit 1 above its softening point. Because of the tension frame 10, the polymer film 5 is not heated with the same intensity in the region of the edge zone 6 as in the region of the through opening 11, such that the film temperature in the edge zone generally remains below the softening point. This leads to a circumferentially stabilized polymer film 5.

The polymer film 5 thus heated is then transported by means of the conveying device 21 into the high-pressure device 26, in which isostatic high-pressure forming is conducted by contacting with a liquid pressure medium.

For this purpose, the high-pressure device 26 comprises a pressure chamber 30 which, as described below, can be opened and closed. The pressure chamber 30 has a first and a second subchamber 31 and 32.

The first subchamber 31 forms a pressure dome and is typically disposed at the top, such that the open cavity 33 of the pressure dome 31 faces downward. Moreover, the first subchamber 31 has an annular contact face 34 facing downward, the inner contour of which here is circular and preferably has the same diameter as the second through opening 11 of the tension frame 10. However, it is also possible that the diameter of the inner contour of the ring-shaped contact face 34 is somewhat smaller or somewhat larger than the diameter of the second through opening 11 of the tension frame 10. The inner contour of the annular contact face may alternatively have a diameter greater than the diameter of the second through opening 11. At the contact face 34 is disposed an annular seal 35 (for example in an annular groove, not shown) that protrudes from the contact face 34. The annular seal 35 may, for example, be circular, oval, polygonal, or may have the shape of any other continuous path.

The first subchamber 31 contains a channel 36 that opens into the cavity 33 and via which a fluid pressure medium can be supplied and removed again, as indicated by the arrows P1 and P2. For this purpose, a valve 37 is shown in schematic form is provided, which performs the supply and removal of the fluid pressure medium.

The second subchamber 32 comprises a base plate 38 that bears the mold 39 with the desired contour 40 for the polymer film 5. In addition, the second subchamber 32 encompasses a chamber wall 41 which is spring-loaded on the base plate 38 and surrounds the mold 39 laterally. For the spring loading, the springs 42 shown in schematic form are provided.

The chamber wall 41 has an end 43 pointing upward, which is in stepped form, where the step height corresponds at least to the thickness of the base frame 2 (the step height may, for example, preferably be minimally above the thickness of the base frame 2, which may, for example, be 50 μm to 10 mm, 0.2 mm to 5 mm, 1 mm to 3 mm, 0.5 mm-2 mm or 0.5 mm to 1 mm), and the portion 44 of the stepped end 43 that protrudes upward has an external diameter which is less than the diameter of the first through opening 3 of the base frame 2 and has an internal diameter corresponding to the diameter of the second through opening 11 of the tension frame 10. In addition, the portion 44 of the stepped end 43 that protrudes upward has a contact face 45.

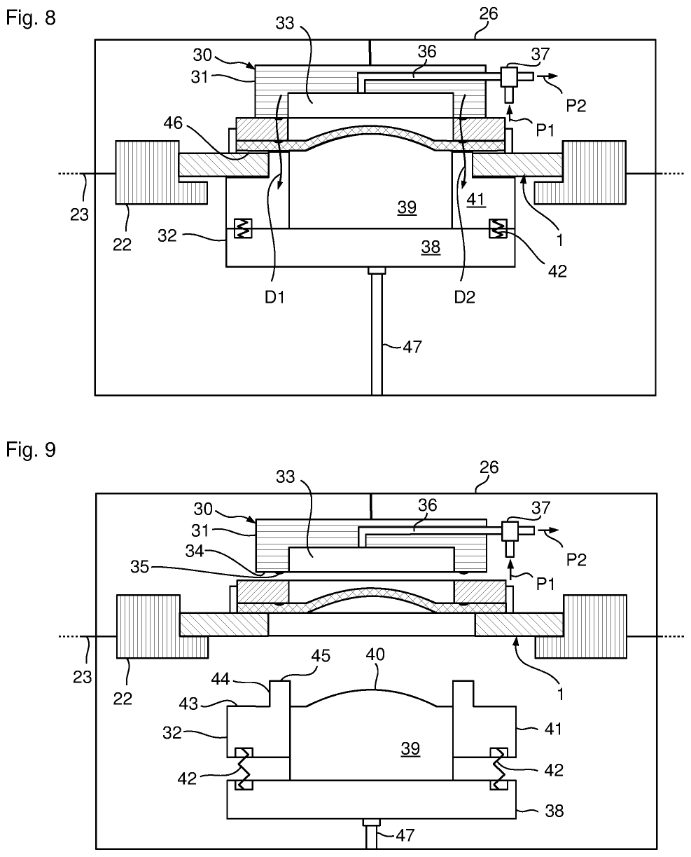

In the representation shown by FIG. 7, the pressure chamber 30 is shown in its open position, in which the slide 22 with the fixing unit 1 can be positioned between the two subchambers 31 and 32. As soon as the slide 22 has been appropriately positioned, a lift device 47 can be used to move the second subchamber 32 upward in the direction of the first subchamber 31, as a result of which the second subchamber 32, by means of the stepped end 43, lifts the fixing unit 1 off the slide 22. When the step height of the portion 44 protruding upward is greater than the thickness of the base frame 2, the portion 44 pointing upward lifts the polymer film 5 (the contact face 45 presses against the polymer film 5) off the base frame 2 together with the tension frame 10, such that there is an air gap 46 between the polymer film 5 and the base frame 2, as shown schematically in FIG. 8. At the same time, the mold 39 is moved upward relative to the chamber wall 41 in that the base plate 38 is in contact with a bottom side of the wall 41 against the force exerted by the springs 42. As a result, the mold 39 with its contour 40 is already in contact with the polymer film 5 (as shown in FIG. 8) or has a small distance from the polymer film 5.

As can also be inferred from FIG. 8, the pressure chamber 30 is thus closed, with the seals 35 and 15 and the contact of the contact face 45 with the polymer film 5 resulting in the necessary sealing of the pressure chamber 30 (indicated by the arrows D1 and D2) to the polymer film 5 clamped between the two subchambers 31 and 32. Thus, the tension frame 10 is part of the pressure chamber 30.

In this closed position of the pressure chamber 30 shown in FIG. 8, the fluid pressure medium is guided into the cavity 33 via the channel 36, giving rise to a positive pressure that leads to isostatic deformation of the polymer film 5, which is thus pressed against the contour 40 of the mold 39.

Thereafter, the fluid pressure medium is removed from the cavity 33 and, to the extent necessary, sufficient cooling of the deformed polymer film 5 is awaited with the pressure chamber 30 closed.

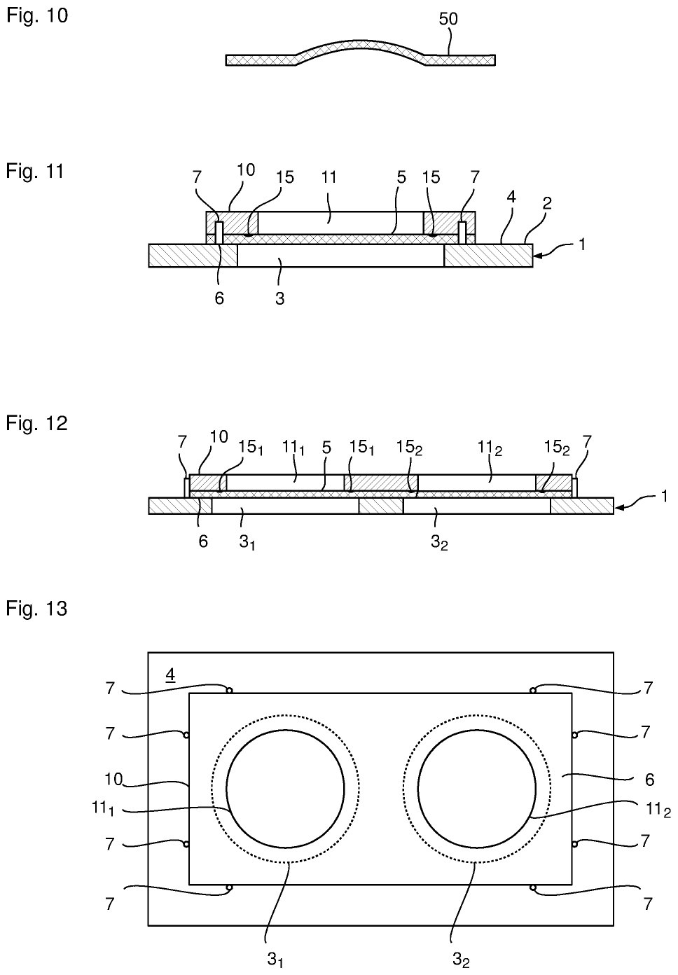

The performance of this deformation of the polymer film 5 results in the desired polymer molding 50, and the pressure chamber 30 is returned to its open position (FIG. 9). The fixing unit 1 is laid back on the slide 22 here, and is transported back to the load/unload position together with the deformed polymer film 5. Thus, a polymer molding 50 (FIG. 10) has been produced from the polymer film 5 in the manner described.

In all movements of the slide 22, the pins 7 serve to ensure that the polymer film 5 and the tension frame 10 retain their position.

Since the polymer film 5 is positioned in the fixing unit 1 both in the course of heating and in the course of deforming, the polymer film 5 is always fixed or clamped in the edge zone 6 around the entire first through opening 3, such that warpage of the shape of the polymer film 5 can be very substantially prevented in the course of heating above the softening point and in the course of deforming. When the polymer film 5, as shown in FIG. 8, has been lifted off the base frame 2, the desired fixing is implemented by the contact face 45 that presses the polymer film 5 against the bottom side 13 of the tension frame 10. Such warpage would occur especially because the polymer films 5 used are generally produced via an extrusion process (e.g. flat film extrusion process) and processed further via rolls in order to establish film thickness and surface quality. This leads to intrinsic anisotropic stresses in the material that are released on heating and would then lead to unwanted warpage in a variant known to date, where the polymer film 5 is merely placed on the base frame 2 and no tension frame 10 is provided.

In the working example described so far, the polymer film 5 is fixed mainly by means of the weight force of the tension frame 10 lying on top. However, it is additionally or alternatively possible, by means of spikes, teeth and/or a rough surface, to achieve the desired fixing, where the spikes, teeth and/or the rough surface may be formed on the top side 4 of the base frame 2 and/or on the bottom side 13 of the tension frame 10. It is also additionally or alternatively possible to implement a mechanical screw connection or clamping (by means, for example, of a clamping lever, springs, etc.). Fixing by magnetic forces is also additionally or alternatively possible.

The polymer film may, for example, be a PC film (polycarbonate film). For example, the PC film may be Makrofol© DE 1-1 from Covestro Deutschland AG from Germany. The layer thickness of the polymer film 5 (or of the film piece 5) may, for example, be in the range from 10 μm to 3000 μm, from 12 μm to 2000 μm, from 100 μm to 2000 μm, from 150 μm to 1000 μm, from 125 μm to 1000 μm (or 175 μm to 1000 μm), from 125 μm to 750 μm, from 125 μm to 600 μm, from 150 μm to 650 μm and from 250 μm to 600 μm or from 200 μm to 500 μm. In particular, the layer thickness of the polymer film 5 may be in the range from 350 μm to 650 μm or from 375 μm to 500 μm.

In the case of deformation in the high-pressure device 26, the fluid pressure medium can be fed in at 2 to 300 bar and preferably at 10 to 100 bar.

Further details of high-pressure deformation can be found, for example, in DE 10 2008 050 564 A1, the content of which is hereby incorporated here.

The softening temperature of the PC polymer film 5 used may be in the range from 144 to 146° C. In the case of heating above the softening temperature, therefore, a temperature of greater than 146° C. and preferably less than 190° C. is generated in the heating device 25.

The polymer film may include any polymer that the person skilled in the art would select for forming. In particular, the polymer is a thermoplastic polymer.

After the forming step described, further steps may still be conducted in order to obtain a desired end product from the polymer molding 50. In particular, it is possible, for example, to conduct a stamping step, a coating step, etc. It is of course also possible that the polymer molding 50 itself is the desired end product.

Since the fixing unit 1 is provided as a separate unit that has to be placed on the slide 22 in the load/unload position, the fixing unit 1 may be loaded externally and then placed into the high-pressure deformation apparatus 20 as a unit and removed again after the deforming. When the tension frame 10 takes the form of a pure lay-on frame (for example with sealing ring 15), the incorporation into the fixing unit 1 and the deinstallation from the fixing unit 1 can be effected in a rapid and uncomplicated manner without any significant effect on the existing process. The handling steps with regard to the polymer film 5 are minimized, which also leads to lower contamination.

However, it is also possible to dispose the base frame 2 directly in the slide 22 in the loading/unloading station and only to place on the polymer film 5 and the tension frame 10 in the manner described. On completion of forming, the tension frame 10 can be lifted off and the polymer molding 50 formed can be removed. Thereafter, a new polymer film 5 and the tension frame 10 on top can be placed on again, such that a further forming process can be conducted.

In addition, it is possible to conduct automation, for example in such a way that the laying of the polymer film 5 and of the tension frame 10 onto the base frame and the removal of the formed polymer molding 50 after the forming is conducted in an automated manner after the tension frame 10 has been lifted off.

FIG. 11 shows a modification of the inventive fixing unit 1. In this modification, the polymer film 5 and the tension frame 10 are placed onto the pins 7. For this purpose, the polymer film 5 has through openings and the tension frame 10 has corresponding blind holes or through holes.

FIGS. 12 and 13, in the same way as FIGS. 1 and 2, show a modification of the inventive fixing unit 1. In this modification, the base frame 2 has two through openings 3₁ and 3₂. In the same way, the tension frame 10 has two through openings 11₁ and 11₂ and two seals 15₁ and 15₂. Such a fixing unit 1 can double the throughput in the forming operation, since it is always possible to produce two polymer moldings 50. For this purpose, the apparatus 20 for high-pressure forming is of course correspondingly adapted. For instance, in the heating device 25, the polymer film 5 can be heated such that the regions in both through openings 11₁ and 11₂ of the polymer film are heated in the manner described. There are then two pressure chambers 30 (one each for each pair of through openings 3₁, 11₁ and 3₂ and 11₂) in the high-pressure apparatus 26.

It is of course also possible to provide only one pressure chamber 30 for both pairs of through openings 3₁, 11₁ and 3₂, 11₂. In addition, it is possible to provide identical or different molds 39 with identical or different contours 40. It is of course also possible to provide more than two pairs of through openings.

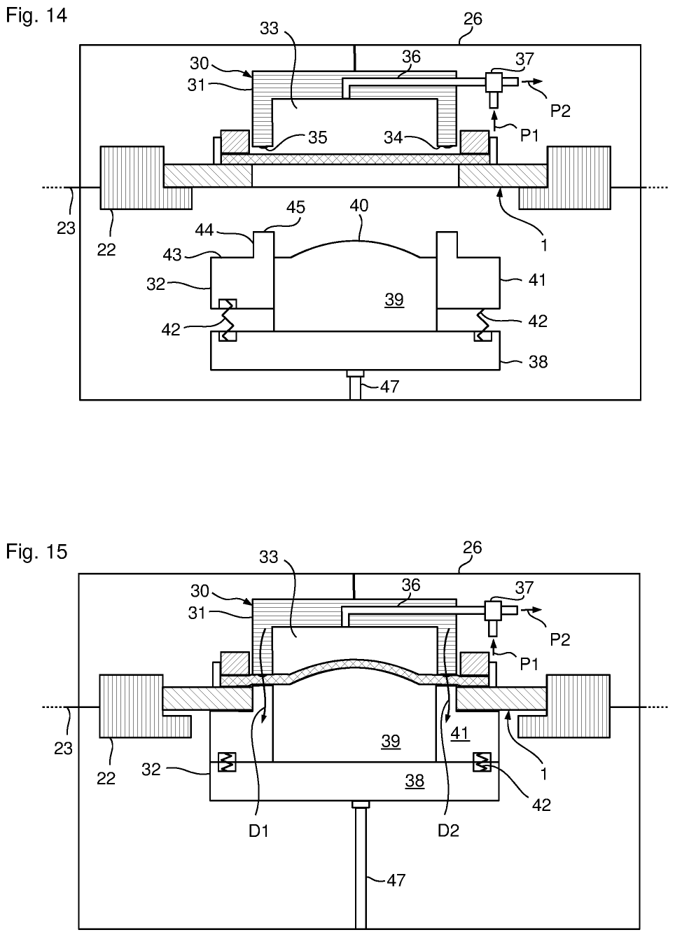

FIGS. 14 and 15, in the same way as FIGS. 7 and 8, show a further inventive fixing unit 1 and a further process for production of a polymer molding 50.

In this embodiment, the pressure chamber 30 is formed such that neither the base frame 2 nor the tension frame 10 is part of the pressure chamber 30. Instead, the polymer film 5 is clamped directly between the wall 41 and the pressure dome 31, as indicated in FIG. 15 by the arrows D1 and D2. In that case, for example, as shown in FIGS. 14 and 15, it is possible to dispense with an annular seal in the tension frame 10.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-12. (canceled)

13. A method of producing a polymer molding, comprising
(a) placing a polymer film onto a base frame having a first through opening such that the polymer film fully covers the first through opening and lies on an edge zone of a top side of the base frame that bounds the first through opening;
(b) heating the polymer film lying on the base frame; and
(c) contacting the polymer film that lies on the base frame, which has been heated in step (b), with a fluid pressure medium such that the polymer film is pressed against a mold and hence formed into the polymer molding,
wherein a tension frame having a second through opening is positioned in step (a) on the polymer film lying on the base frame such that the tension frame presses and hence fixes the polymer film against the top side of the base frame in the region of the edge zone, and in that the second through opening of the tension frame lies at least partly opposite the first through opening of the base frame, and
wherein step (b) is conducted with the polymer film fixed between the base frame and the tension frame.

14. The method of claim 13, wherein the forming in step (c) is conducted isostatically.

15. The method of claim 13, wherein the tension frame in steps (a) and (b) presses the polymer film against the top side of the base frame along a continuous pathway that surrounds the first through opening.

16. The method of claim 13, wherein the tension frame has an annular groove that surrounds the second through opening and in which there is a seal that presses against the polymer film in steps (a) and (b).

17. The method of claim 13, wherein the base frame has multiple stop elements that protrude from its top side, and wherein both the polymer film and the tension frame are positioned between the protruding stop elements in step (a).

18. The method of claim 13, wherein the tension frame has a planar top side which lies atop the polymer film after performance of step (a).

19. The method of claim 13, wherein the tension frame and/or the base frame, in the region of the edge zone, has spikes, teeth and/or a rough surface for fixing of the polymer film.

20. The method of claim 13, wherein a clamping means is provided, which subjects the tension frame to a force that presses the tension frame against the base frame and hence increases the clamping effect already exerted on the polymer film due to the weight force of the tension frame.

21. The method of claim 13, wherein step (c) includes conducting the forming of the polymer film in a pressure chamber, wherein the pressure chamber is formed via a wall that surrounds the mold that presses the polymer film against the tension frame, such that the tension frame is part of the pressure chamber and the base frame is not part of the pressure chamber.

22. The method of claim 13, wherein step (c) includes conducting the forming of the polymer film in a pressure chamber, wherein the pressure chamber is formed via the polymer film being clamped directly between a wall that surrounds the mold and a wall of a first subchamber, such that both the tension frame is not part of the pressure chamber and the base frame is not part of the pressure chamber.

23. A fixing unit for fixing of a polymer film for an apparatus for high-pressure forming, the fixing unit comprising:
a base frame, comprising a first through opening and a top side; and
a tension frame;
wherein the polymer film is placed onto the base frame such that it fully covers the first through opening and lies on an edge zone of the top side of the base frame that bounds the first through opening,
wherein the tension frame comprises a second through opening and lies on the polymer film such that the latter is pressed and hence fixed against the top side of the base frame in the region of the edge zone, and
wherein the second through opening of the tension frame lies at least partly opposite the first through opening of the base frame.

24. A high-pressure forming apparatus, comprising:
a conveying device,
a heating device; and
a high-pressure device,
wherein the conveying device is configured to transport the fixing unit of claim 23 into the heating device and the high-pressure device.
